(19) United States
(12) Patent Application Publication
(10) Pub. No.: US 2026/0228522 A1
(43) Pub. Date: Aug. 6, 2026

(54) MITIGATING LOSS OF PLASTICITY WHEN TRAINING NEURAL NETWORKS

(71) Applicant: GDM Holding LLC, Mountain View, CA (US)

(72) Inventors: Razvan Pascanu, Letchworth Garden City (GB); Junhyuk Oh, London (GB); Clare Marie Bennison Lyle, Seattle, WA (US); Andre da Motta Salles Barreto, London (GB)

(21) Appl. No.: 19/151,397

(22) PCT Filed: Jan. 26, 2024
(86) PCT No.: PCT/EP2024/051915

§ 371 Date: Jul. 28, 2025

Related U.S. Application Data
(60) Provisional application No. 63/481,780, filed on Jan. 26, 2023.

(51) Int. Cl. G06N 3/08

(52) U.S. Cl. CPC G06N 3/08

(57) ABSTRACT

A system and method of training neural networks that can be used to mitigate loss of plasticity is provided. The method comprises: obtaining an original neural network including an output subnetwork, training the original neural network during a first training phase and then creating first and second versions of the output subnetwork. An updated neural network is formed comprising the original neural network and the first and second versions of the output subnetwork. Trainable parameters of the first and second versions of the output subnetwork are initialized and the trainable parameters of the second version of the output subnetwork are then frozen after the initialization. The updated neural network is then trained during a second training phase by processing second training data items using the updated neural network and using the resulting updated network outputs to update the trainable parameters of the updated neural network that are not frozen.

### BACKGROUND

This specification relates to training neural networks.

Neural networks are machine learning models that employ one or more layers of nonlinear units to predict an output for a received input. Some neural networks are deep neural networks that include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

In a reinforcement learning system, an agent interacts with an environment by performing actions that are selected by the reinforcement learning system in response to receiving observations that characterize the current state of the environment. Some reinforcement learning systems select the action to be performed by the agent in response to receiving a given observation in accordance with an output of a neural network.

### SUMMARY

This specification generally describes a method of training neural networks that can be used to mitigate loss of plasticity, i.e. the ability of the neural networks to learn from new data. Some implementations of the method are particularly useful in reinforcement learning.

In one aspect there is described a method performed by one or more computers, and a corresponding system. The method can be used for reducing plasticity loss, i.e. an ability to learn from new data, when training a neural network.

In implementations, the method obtains an original neural network including an output subnetwork. The original neural network is configured to process a network input in accordance with trainable parameters of the original neural network to generate, from the output subnetwork, an original network output.

The method involves training the original neural network during a first training phase. The training can comprise processing first training data items using the original neural network to generate original network outputs for the first training data items, and updating the trainable parameters of the original neural network using the original network outputs.

The method also involves creating first and second versions of the output subnetwork, e.g. at an end of the first training phase, and initializing trainable parameters of the first and second versions of the output subnetwork. In implementations, the trainable parameters of the second version of the output subnetwork are frozen after the initializing. Herein “frozen” means that the parameters are left unchanged after freezing, e.g. left unchanged during training.

An updated neural network can be formed, comprising the original neural network and the first and second versions of the output subnetwork. The updated neural network can be configured to process the network input to generate an updated network output from a combination of the original network output, a first network output from the first version of the output subnetwork, and a second network output from the second version of the output subnetwork. Initializing the trainable parameters of the first and second versions of the output subnetwork can be done before or after forming the updated neural network.

The method can then train the updated neural network during a second training phase. This training can comprise processing second training data items using the updated neural network to generate updated network outputs for the second training data items, and updating the trainable parameters of the updated neural network that are not frozen, using the updated network outputs. The network outputs from the updated neural network (when processing the second training data items) are used to train the updated neural network. The second training data items may be the same as or different to the first training data items.

In implementations, the trainable parameters of the first version of the output subnetwork are initialized, e.g. randomly, and then the trainable parameters of the second version of the output subnetwork are initialized to the values that the (corresponding) trainable parameters of the first version of the output subnetwork were initialized to. The updated network output may be generated by combining, in particular summing, the original network output and the first network output, and subtracting second network output; each of these outputs may have an equal weight in the sum/subtraction. In implementations, the updated network output is generated by determining

$$h ( x ) + {h}_{1}^{′} ( x ) - {h}_{2}^{′} ( x )$$

where h(x) is the original network output,

$${h}_{1}^{′} ( x )$$

is the first network output, and

$${h}_{2}^{′} ( x )$$

is the second network output. By initializing the trainable parameters of the second version of the output subnetwork to the values of the first version of the output subnetwork, and then subtracting the second network output from the combined network output, bias from the introduction of one or more additional subnetworks used to form the updated neural network can be mitigated, e.g. bias arising from the values used to initialize the additional subnetwork(s). That is, the output from the first version of the output subnetwork may be cancelled by the output from the second version of the output subnetwork initially, i.e. at least prior to the second training phase.

Some implementations of the method also freeze the trainable parameters of the output subnetwork (of the original neural network) before the second training phase, e.g. after the initializing. Thus, during the second training phase, the first version of the output subnetwork may learn to predict changes to the original network output.

In some implementations the first and second versions of the output subnetwork have the same neural network architecture as one another; in some implementations they are copies of the output subnetwork. In some implementations the first and second versions of the output subnetwork are copies of the output subnetwork each with the same (corresponding) respective neural network architecture. Thus, the output subnetwork and the first and second versions of the output subnetwork may all have identical parameters (i.e. the same number of parameters, each with the same value as the corresponding parameter in the other two output subnetworks).

In general, the original neural network and the output subnetwork can have any architecture: the described techniques are not limited to any particular architecture. For example the original neural network and the output subnetwork can include one or more of a feedforward layer, a recurrent layer, a convolutional layer, and a neural network layer including an attention mechanism.

Training the updated neural network can comprise backpropagating gradients of a training objective function through each of the output subnetwork, the first version of the output subnetwork, and the second version of the output subnetwork to update the trainable parameters of the updated neural network that are not frozen. That is, in implementations gradients of the training objective function are backpropagated through the frozen parameters (without updating these), to update parameters that are deeper in the neural network (towards the network input).

In some implementations the original neural network includes a second subnetwork, e.g. an encoder subnetwork, configured to process the network input, in accordance with trainable parameters of the second subnetwork, to generate a second subnetwork output. The output subnetwork can be configured to process the second subnetwork output to generate the original network output. In some implementations the second subnetwork and the output subnetwork together make up the entire the original neural network.

In such implementations, forming the updated neural network can comprise sharing the second subnetwork between the original neural network and the first and second versions of the output subnetworks. The method may then further comprise processing the network input using the second subnetwork to generate the second subnetwork output, and processing the second subnetwork output using (each of) the output subnetwork, the first version of the output subnetwork, and the second version of the output subnetwork to generate the updated network output. Training the updated neural network can include updating the trainable parameters of the second subnetwork.

In some implementations the method creates first and second versions of the complete original neural network (including the output subnetwork). The method can then initialize (all) trainable parameters of the first and second versions of the original neural network, e.g. as previously described for the output subnetwork; and the trainable parameters of the second version of the original neural network can be frozen after the initializing. Then the updated neural network comprises the original neural network and the first and second versions of the original neural network.

The method may then further comprise processing the network input using the original neural network, the first version of the original neural network, and the second version of the original neural network; generating the first network output from the first version of the original neural network; and generating the second network output from the second version of the original neural network. That is the original, first, and second network outputs may all be combined to generate the updated network output.

In some implementations the original neural network further comprises a second subnetwork, e.g. an encoder. The method may then create first and second versions of the second subnetwork, e.g. first and second copies of the second subnetwork. The method may then initialize trainable parameters of one or both of the first and second versions of the second subnetwork to values of the trainable parameters of the second subnetwork, i.e. to copy the parameters of the second subnetwork to the first and/or second versions of this subnetwork. The method may also freeze the trainable parameters of the second version of the second subnetwork.

Forming the updated neural network may then comprise configuring the updated neural network to process the network input using each of i) the second subnetwork, ii) the first version of the second subnetwork, and iii) the second version of the second subnetwork, to generate respective outputs processed by i) the output subnetwork, ii) the first version of the output subnetwork, and iii) the second version of the output subnetwork.

Some implementations of the method can detect a loss of plasticity during the first training phase and, in response, form and train an updated neural network as described above, e.g. by adding first and second network versions of the output subnetwork, and initializing and freezing the trainable parameters as previously described. As used herein, forming and training an updated neural network in this way may be referred to as “plasticity injection”. As one example, detecting the loss of plasticity may comprise determining a norm of the trainable parameters of the original neural network, e.g. a weight norm, and using the norm to detect the loss of plasticity. As another example, detecting the loss of plasticity may comprise identifying a plateau in a performance metric of the training (a metric indicating how well the original neural network is performing on the task it is being trained to perform), such as a value of the training objective function e.g. training loss. In this latter case, before commencing the second training phase the original neural network may be restored from an earlier saved checkpoint, e.g. one from around the time that the performance started to plateau. As some further examples plasticity loss may also be determined based on feature rank (e.g. Kumar et al. arXiv: 2010.14498; Lyle et al., arXiv: 2204.09560), or based on a number of dead units.

The above described method may itself be used to detect a loss of plasticity in the original neural network, by applying the method to determine whether its application results in a training performance metric once again starting to improve.

This may comprise saving a checkpoint of the original neural network during the first training phase, the checkpoint comprising a set of values for the trainable parameters of the original neural network, and then detecting loss of plasticity in the original neural network by comparing a metric of performance of the original and updated neural networks. If loss of plasticity is detected, the original neural network may be restored using the saved checkpoint, and then training of the original neural network may be continued from the saved checkpoint. This continued training can use a modified training process, e.g. a different learning rate, or it may involve a modified training objective, e.g. to add a norm such as a spectral norm, or it may be modified in any other appropriate way.

In some implementations training the updated neural network during the second training phase may comprise training the updated neural network on different, e.g. enhanced hardware compared with hardware used for training the original neural network during the first training phase. Such enhanced hardware may be hardware with more memory or more computing capacity, e.g. more computing operations per second. This can allow a large model to be “resurrected” and training continued when desired, without needing to retrain the model from scratch.

In some implementations the original neural network (and updated neural network) may be part of a larger neural network system; and the network input and network output may be an intermediate input or output in a larger system. As one example, the original neural network (and updated neural network) may be a block in a larger neural network system, e.g. a block with a residual connection. A block is generally a group of one or more neural network layers in a neural network.

There is also described a computer-implemented reinforcement learning neural network system using a method as described above. The reinforcement learning neural network system is used to control an agent interacting with an environment to perform a task. The reinforcement learning neural network system may implement any type of reinforcement learning, e.g. on-policy or off-policy, model-based or model-free, based on Q-learning or a policy gradient approach, using an actor-critic technique; it may, but need not be, a distributed system. In general, the reinforcement learning neural network system uses the original neural network during the first training phase, and then the updated neural network during the second training phase. Use of the updated neural network may mean that the reinforcement learning neural network system regains, at least to some extent, an ability to learn from new observations.

In more detail, a reinforcement learning method implemented by the system may comprise, for each of a plurality of action selection time steps: obtaining an observation for a current time step characterizing a current state of the environment and obtaining the network input from the observation; processing the observation for the current time step using the reinforcement learning neural network system by processing the network input using the original neural network during the first training phase to generate the original network output and by processing the network input using the updated neural network during the second training phase to generate the updated network output; and selecting an action to be performed by the agent in response to the observation, using the original network output during the first training phase and using the updated network output during the second training phase.

As an example, an encoder as described above may be used to process the observation to generate an observation embedding that is processed by the output subnetwork to generate an action selection output (of any type) for selecting the action. Such an embedding may comprise an ordered collection of numerical values, e.g. a vector or matrix of numerical values.

At each time step, the agent receives a reward (which may be zero) based on the current state of the environment and the action performed by the agent at the time step. Generally, the reward is represented as a numerical value; it can be based on any event in or aspect of the environment. For example, the reward may indicate whether the agent has accomplished a task or it may characterize progress of the agent toward accomplishing the task.

In general, the original neural network is trained during the first training phase using a first reinforcement learning objective function, e.g. based on the rewards received, to update the trainable parameters of the original neural network. The updated neural network is trained during the second training phase using a second reinforcement learning objective function (the same as, or different to, the first) to update the trainable parameters of the updated neural network that are not frozen.

In general, the training involves adjusting values of the trainable parameters (that are not frozen), by backpropagating gradients of the first or second reinforcement learning objective function, to encourage (e.g. bias the system so as to cause) an increase in a cumulative measure of rewards received by the agent when performing actions selected using the system. Any appropriate reinforcement learning objective function may be used, e.g. based on a Bellman error or on a policy gradient.

Merely as an example, the agent may be a mechanical agent, such as a robot of vehicle, the environment may be a real-world environment, and the actions may be actions taken by the mechanical agent in the real-world environment to perform the task.

Particular embodiments of the subject matter described in this specification can be implemented so as to realize one or more of the following advantages.

Typically, when a reinforcement learning or other neural network system is trained to perform a task, the performance increases for a time and then the improvement gradually levels off. It would be useful if the performance were to continue to improve. Sometimes the reason for the performance levelling off is apparently due to a loss of plasticity in the neural network system, resulting in the system gradually losing the ability to learn. In general, more learning should yield better performance.

The described techniques address this problem and, in implementations, can provide a way of increasing the plasticity without increasing the number of trainable parameters, e.g. where parameters of both the original output subnetwork and the second version of the output subnetwork are frozen. Further, some implementations of the described techniques can introduce additional plasticity without changing the learned function of the original neural network, which is particularly important in reinforcement learning.

Thus implementations of the described method can enable a trained neural network system to reach a higher level overall performance, and can also save on computational resources by reducing the risk of trying to train a neural network with limited ability to learn.

Implementations of the described method can also allow computational resources to be saved during training by starting from a smaller network and then injecting plasticity at some point during the training. This saving may arise because the full capacity (i.e. number of trainable parameters) of a large neural network may be unnecessary early in training, even if it is useful to maintain plasticity later. Thus, the described method may be used to minimize computations when training neural networks at a large scale. In some implementations, multiple plasticity injections may be used, e.g. such that the method is applied to increase plasticity of the updated neural network after the second training phase.

Implementations of the described method can also enable a train-on-demand approach, training the original neural network to a certain level, ceasing training, then at some later point restarting the training from the point at which it was previously stopped and at the same time increasing the network's capacity to learn. The method may also be used to diagnose a lack or change of plasticity in an original neural network, such that training of the original neural network can be continued with modified hyperparameters to improve learning performance.

In general, the method may be applied more than once, such that the updated neural network generated in a first application of the method becomes the original neural network for a second application of the method, from which a new updated neural network is generated, and so on. Repeated application of the method may therefore allow the effects of plasticity loss to be mitigated each time it occurs. The method may also be applied at any time during training, e.g. at one or more points in the training defined by a user, or automatically, e.g. each time in response to one or more criteria being fulfilled, e.g. identification of a plateau in a performance metric of the training of the neural network and/or a norm of the trainable parameters of the neural network surpassing a threshold.

### BRIEF DESCRIPTION OF THE DRAWINGS

FIG. 1 shows an example neural network system with improved plasticity.

FIG. 2 shows another example neural network system with improved plasticity.

FIG. 3 is a flow diagram of an example process for reducing plasticity loss when training a neural network.

FIG. 4 shows exemplary training curves for an agent performing a task.

Like reference numbers and designations in the various drawings indicate like elements.

### DETAILED DESCRIPTION

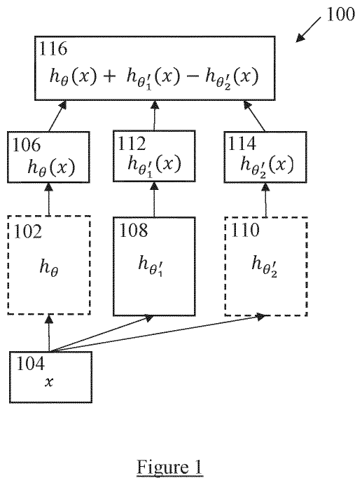

FIG. 1 shows an example neural network system 100 that may be implemented using one or more computers in one or more locations. The system 100 may be created by applying plasticity injection to an “original” neural network 102, e.g. in response to a loss of plasticity being detected for the original neural network 102. As creating the neural network system involves updating the original neural network 102, the system may alternatively be referred to as an “updated” neural network 100.

The original neural network (h_{θ}) 102 is configured to process a network input (x) 104 to generate, in accordance with trainable parameters (θ) of the original neural network 102, an original network output h_{θ}(x) 104. The original neural network 102 is trained in a first training phase by processing first training data items and using the original neural network 102 to generate, in accordance with initialized or current values of the trainable parameters of the original neural network 102, original network outputs for (each of) the first training data items. The trainable parameters of the original neural network are then updated using the original network outputs.

The training may optimize a training objective function e.g. by backpropagating gradients, with respect to the trainable parameters of the original neural network 102, of a training objective function through the original neural network 102. The original neural network 102 may, in general, have any (deep) neural network architecture, such as, but not exclusively, a convolutional neural network (CNN) architecture, a residual neural network (ResNet) architecture, a recurrent neural network (RNN), or a Transformer neural network architecture (or combinations of these and/or other types of neural network architecture). In some implementations, the original neural network 102 may have been pre-trained to optimise a different objective function from that used in the first training function. The first training phase may then be regarded as fine-tuning the original neural network 102.

The updated neural network 100 further comprises first 108 and second 110 versions of the original neural network 102 that are each configured to process the network input 104 and generate, in accordance with trainable parameters, respective network outputs. That is: the first version 106 of the original neural network 102 is configured to generate, in accordance with trainable parameters

$$( {h}_{{θ}_{1}^{′}} )$$

of the first version of the original neural network 102, a first network output 112; and the second version 110 of the original neural network 102 is configured to generate, in accordance with trainable parameters

$$( {h}_{{θ}_{2}^{′}} )$$

of the second version of the original neural network 102, a second network output 114. In the implementation shown in FIG. 1, the first 108 and second 110 versions of the original neural network 102 have the same neural network architecture as one another (e.g. they may be copies of the original neural network 102), but in other implementations they may have different neural network architectures, i.e. different from one another and/or from the original neural network 102.

In the present implementation, the trainable parameters of the first version 108 of the original neural network 102 and the trainable parameters of the second version 110 of the original neural network 102 are initialized to the same to the values as one another, e.g. by initializing the trainable parameters of the first version 108 of the original neural network 102 and then initializing the trainable parameters of the second version 110 of the original neural network 102 to the same to the values the corresponding trainable parameters of the first version 108 of the original neural network 102 (or vice versa). In some other implementations, however, the trainable parameters of the first 108 and second 110 versions of the original neural network 120 can be initialized to different values, e.g. different random values.

The trainable parameters of the second version 112 of the original neural network 102 are frozen after the initializing, i.e. the updated neural network 100 is configured such that the second training phase does not cause the trainable parameters of the second version of the original neural network 102 to be updated. In some implementations, such as the implementation shown in FIG. 1, the trainable parameters of the original neural network 102 are also frozen before the second training phase, e.g. after the initializing. Freezing of the trainable parameters of the original neural network 102 and the second version 114 of the original neural network 102 is indicated in FIG. 1 by the use of broken, rather than solid, lines for these networks.

The updated neural network 100 is configured to generate an updated network output 116 from a combination of the original network output 106, the first network output 112 from the first version 108 of the original neural network 102, and a second network output from the second version of the original neural network 102. In the updated neural network 100 of FIG. 1, the network output 116 is generated by summing the original network output 106 and the first network output 108 and subtracting the second network output 110. That is, the network output 116 is determined from a linear combination of these network outputs,

$${h}_{θ} ( x ) + {h}_{{θ}_{1}^{′}} ( x ) - {h}_{{θ}_{2}^{′}} ( x ) ,$$

where h_{θ}(x) is the network output 106 from the original neural network 106,

$${h}_{{θ}_{1}^{′}} ( x )$$

is the first network output 112 and

$${h}_{{θ}_{2}^{′}} ( x )$$

is the second network output 114. Generating the updated network output 116 this way may allow bias caused by the introduction the first 112 and second 114 versions of the original neural network 102 to be mitigated because the initial change to the original network output 106 can be minimized (e.g. it may be zero). Initial predictions (i.e. updated network outputs 116) made by the updated neural network 100 before the second training phase may therefore be the same as those (i.e. original network outputs 106) for the original neural network 102 for a given network input 104. Freezing the trainable parameters of the original neural network 102 and the second version 110 of the original neural network 102 may also allow the updated neural network 100, in particular the first version 108 of the original neural network 102, to learn changes to the predictions of the original neural network 102 efficiently during training of the updated neural network 102.

The updated neural network 100 is trained during a second training phase by processing second training data items using the updated neural network 100 to generate updated network outputs 116 for the second training data items. The trainable parameters of the updated neural network 100 that are not frozen are then updated using the updated network outputs 116. As training progresses, the trainable parameters of the first version 112 of the original neural network 102 deviate from the trainable parameters of the second version 114 of the original neural network 102, such that

$${h}_{{θ}_{1}^{′}} ( x ) - {h}_{{θ}_{2}^{′}} ( x )$$

serves as a bias term for the network output 116 of the updated neural network 100.

The second training data items may be the same as or different from the first training data items. For example, loss of plasticity of the original neural network 102 during the first training phase may mean that continuing to use the first training data items in the second training phase is beneficial. Such re-use of the training data items may therefore allow improved results to be obtained for a given set of training data items, or else reduce the need for more training data items to be obtained to achieve a satisfactory level of performance by the updated neural network 100.

Training the updated neural network 100 can comprise optimizing a training objective function, which may be the same as or different from the training objective function used in updating the trainable parameters of the original neural network 102. For example, the training may comprise backpropagating gradients of the training objective function through the first version 108 of the original neural network 102 to update the trainable parameters of the first version 108 of the original neural network 100.

Freezing the trainable parameters of the original neural network 102 and the second version 114 of the original neural network 102 means that the number of trainable parameters in the updated neural network 100 that are updated during the second training phase may be the same as the number of trainable parameters in the original neural network 102 that are updated during the first training phase. Thus, the computational resources needed for training the updated neural network 100 may remain similar to those needed to train the original neural network 102.

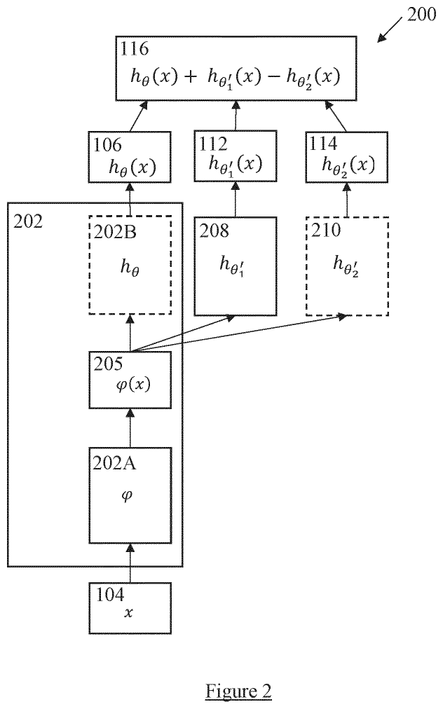

FIG. 2 shows a further example neural network system or “updated” neural network 200 that may be implemented using one or more computers in one or more locations. The updated neural network 200 of FIG. 2 is similar to the updated neural network 100 of FIG. 1, except that the original neural network 202 comprises an output subnetwork (h_{θ}) 202B and a second subnetwork (φ) 202A, e.g. an encoder subnetwork. The second subnetwork 202A is configured to process the network input (x) 104, in accordance with trainable parameters of the second subnetwork 202B, to generate a second subnetwork output φ(x) 205. The output subnetwork (h_{θ}) 202B is configured to process, in accordance with trainable parameters (θ) of the output subnetwork, the second subnetwork output 205 to generate the original network output h_{θ}(x) 206. In some implementations, the second subnetwork 202A and the output subnetwork 202B together make up the entire the original neural network 202, as shown in FIG. 2.

During the first training phase, the trainable parameters of the output subnetwork 202B are updated. The trainable parameters of the second subnetwork 202A may also be updated during the first training phase in some implementations.

The updated neural network 200 comprises first 208 and second 210 versions of the original neural network 202 that do not include the second subnetwork 202B. That is, the updated neural network 200 comprises the original neural network 202 and first

$$( {h}_{{θ}_{1}^{′}} )$$

208 and second

$$( {h}_{{θ}_{2}^{′}} )$$

210 versions of the output subnetwork 202B. The first 208 and second 210 versions of the output subnetwork 202B are each configured to process the second subnetwork output 205 and to generate, respectively, the first network output 112 and the second network output 114.

The updated neural network 200 is configured to process the network input (x) to generate the updated network output 116 from a combination of the original network output 106, the first network output 112 from the first version 208 of the output subnetwork 202B, and the second network output 114 from the second 114 version of the output subnetwork 202B. For example, the network output 116 may be determined from

$${h}_{θ} ( x ) + {h}_{{θ}_{1}^{′}} ( x ) - {h}_{{θ}_{2}^{′}} ( x ) ,$$

as shown in FIG. 2, or some other linear combination of the original network output 206, the first network output 112 and the second network output 114.

The trainable parameters

$$( {θ}_{1}^{′} , {θ}_{2}^{′} )$$

of the first 208 and second 210 versions of the output subnetwork 202B are initialized to the same values. During the second training phase, the trainable parameters of the output subnetwork 202B and the trainable parameters of the second version 210 of the output subnetwork 202B are kept frozen, which is indicated in FIG. 2 by broken lines.

Training the updated neural network 200 may, for example, comprise backpropagating gradients of a training objective function through each of the output subnetwork 202B, the first version 208 of the original neural network 202, and the second version 210 of the original neural network 202 to update the trainable parameters of the updated neural network 200 that are not frozen. In some implementations, training the updated neural network 200 can include updating the trainable parameters of the second subnetwork 202A.

In some other implementations, the first 208 and second 210 versions of the original neural network 202 also comprise, in addition to the first and second versions of the output subnetwork, respective versions of the second subnetwork 202A. In that case, forming the updated neural network 200 comprises configuring the updated neural network 200 to process the network input 104 using each of i) the second subnetwork 202A, ii) the first version of the second subnetwork 202A, and iii) the second version of the second subnetwork 202A, to generate respective outputs processed by i) the output subnetwork 202B, ii) the first version 208 of the output subnetwork 202B, and iii) the second version 210 of the output subnetwork 202B. The trainable parameters of the first and/or second version of the second subnetwork 202B may be frozen during the second stage of training, or they may be updated during the second training phase.

In general, training of the original neural network 102, 202 and the updated neural network 100, 200 (i.e. the first and second training phases) can be carried out by any appropriate neural network training method, e.g., using an optimizer such as RMSprop or Adam (Adaptive Moment Estimation).

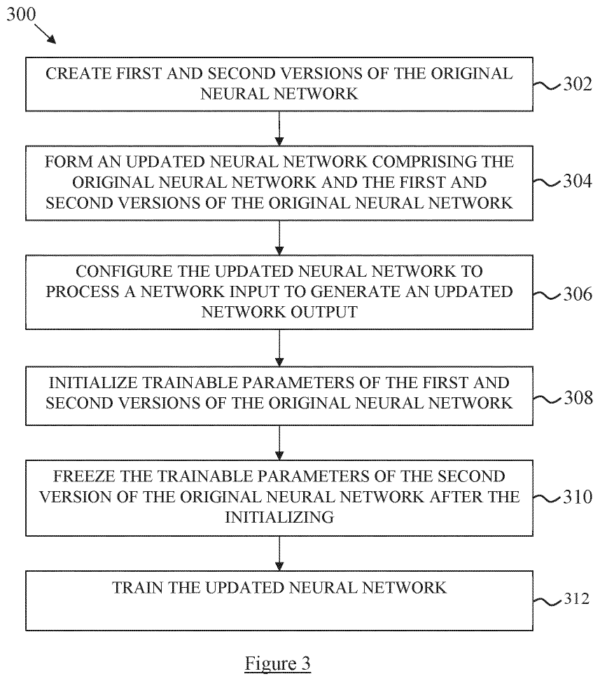

FIG. 3 is a flow diagram of an example process for reducing plasticity loss in a neural network, such as the original neural networks 102, 202 described above with reference to FIGS. 1 and 2. For convenience, the process 300 will be described as being performed by a system of one or more computers located in one or more locations. A neural network designated as an “original” neural network, such as the original neural networks 102, 202 described above in connection with FIGS. 1 and2, is provided as an input to the process 300.

The original neural network is configured to process a network input in accordance with trainable parameters of the original neural network to generate (e.g. from an output subnetwork), an original network output. The original neural network may have already been trained or can be trained as an initial part (a first training phase) of the process 300. For example, the process 300 may comprise training the original neural network during a first training phase, the training comprising processing first training data items using the original neural network to generate original network outputs for the first training data items, and updating the trainable parameters of the original neural network using the original network outputs. The output of the process 300 is an updated neural network, such as one of the updated neural networks 102, 202 described above in connection with FIGS. 1 and 2.

The process 300 comprises creating (step 302) first and second versions of the original neural network and forming (step 304) an updated neural network comprising the original neural network and the first and second versions of the original neural network.

Depending on the implementation of the process 300 and/or the architecture of the original neural network, the first and second versions of the original neural network may comprise some (e.g. only an output subnetwork, as described above for the updated neural network 202 of FIG. 2), or all of the original neural network (as described above for the updated neural network 102 of FIG. 1).

The process 300 further comprises configuring (step 306) the updated neural network to process a network input to generate an updated network output from a combination of the original network output, a first network output from the first version of the output subnetwork, and a second network output from the second version of the output subnetwork. For example, the updated network output may be generated by summing the original network output and the first network output and subtracting the second network output.

The process 300 also comprises initializing (step 308) trainable parameters of the first and second versions of the original neural network and freezing (step 310) the trainable parameters of the second version of the original neural network after the initializing. The trainable parameters of the original neural network (or output subnetwork) may also be frozen in some implementations. The initializing may be performed by initializing the trainable parameters of the first version of the original neural network, and then initializing the trainable parameters of the second version of the original neural network to the values of the corresponding trainable parameters of the first version of the original neural network. In some implementations, the first and second versions of the original neural network are first and second copies of the original neural network.

The process 300 then comprises training (step 312) the updated neural network. The training comprises processing second training data items using the updated neural network to generate updated network outputs for the second training data items, and updating the trainable parameters of the updated neural network that are not frozen, using the updated network outputs. The second training data items may be the same as or different from the first training data items.

The training of the updated neural network may be performed by backpropagating gradients of a training objective function through each of the original neural network (or output subnetwork), the first version of the output subnetwork, and the second version of the output subnetwork to update the trainable parameters of the updated neural network that are not frozen.

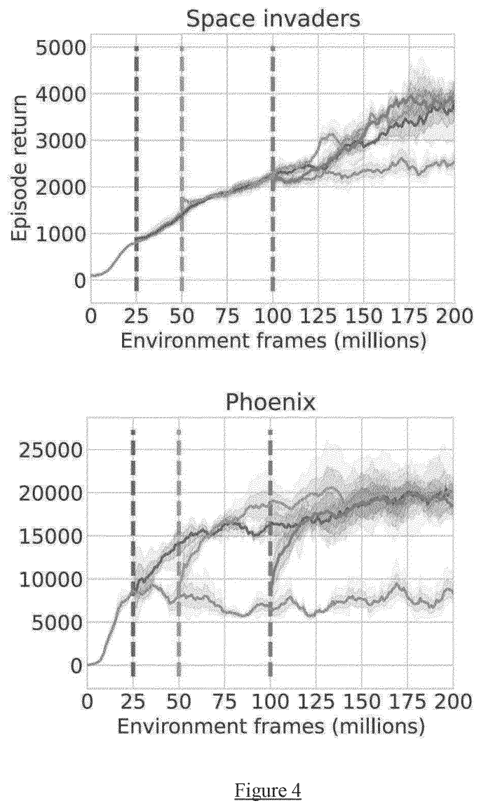

FIG. 4 shows two sets of example results from using the plasticity injection techniques described herein, such as the process 300 described in connection with FIG. 3, to improve the performance of an agent as it learns to carry out a task, in this case the playing of Atari games from the Arcade Learning Environment, which has been used to assess agents trained using reinforcement learning. The agent used in this case is a “DoubleDQN” agent, as described in Van Hasselt et al., “Deep reinforcement learning with double Q-Learning” in Proceedings of the AAAI conference on artificial intelligence, Volume 30, 2016. In addition to the results shown in FIG. 4, the methods described herein have been found to improve an aggregate score across 57 Atari games by 20% compared to other methods for dynamically addressing plasticity loss.

In the absence of plasticity injection, the performance of the agent in carrying out the task, as measured by an “episode return”, demonstrates diminishing improvements over time (expressed as “environment frames” of the game) leading to a performance plateau. This baseline performance may be attributed to a loss of plasticity in the deep neural networks used by the agent to select actions during performance of the task. Plasticity injection, i.e. the formation and training of an updated neural network, can be carried out at different times during the training of the agent, as represented by the vertical broken lines in FIG. 4 at 25M, 50M and 100M environment frames.

For the particular tasks considered in FIG. 4, the use of plasticity injection is observed to allow the agent to achieve higher returns compared to the baseline agent, with performance improvements being achieved for both tasks. In particular, the returns for the “Phoenix” task are observed to double following plasticity injection. For the “Space invaders” task, the post-injection agent is observed to improve at a faster rate than the baseline agent, which is indicative of decreasing neural network plasticity over the course of training. For the “Phoenix” task, plasticity injection at earlier times during the training is observed to lead to earlier above-baseline performance by the agent, indicating that (catastrophic) plasticity loss may have occurred for this task at an early point during the training, e.g. at around 25M frames. Thus, plasticity injection at different stages of training can be used to identify or diagnose when, and/or the extent to which, plasticity loss occurs for particular neural networks during training. Conversely, a lack of significant changes, compared to the baseline agent, to the performance of the agent following plasticity injection may, in some cases, be indicative of the agent encountering exploration challenges, e.g. failing to gain suitable rewards from the environment.

In some implementations, the first and second versions of the original neural network 102, 202 or the output subnetwork 202B described above with reference to FIGS. 1 and 2 may be created in response to a loss of plasticity being detected during the first phase of training the original neural network 102, 202. That is the updated neural networks 100, 200 may be configured to detect when there has been a loss of plasticity in the original neural network 102, 202 during the first training phase and, in response, use plasticity injection, i.e. the formation and training in a second training phase of an updated neural network 100, 200, to increase learning ability. Thus, the duration of the first training phase may be determined based on one or more termination criteria indicative of a loss plasticity of the original neural network 102, 202, including, for example: identification of a plateau in a performance metric of the training of the original neural network 102, 202; and/or a norm of the trainable parameters of the original neural network 102, 202, e.g. a weight norm, surpassing a threshold.

Alternatively or additionally, plasticity injection may be performed at one or more predetermined test points (e.g. after certain numbers of first training data items have been processed) during the first training phase and the performance of a respective updated neural network (that included the original neural network at a checkpoint closest to the test point) in a second training phase then assessed to decide whether to continue training the updated neural network 100, 200, or to otherwise continue to train the original neural network 102, 202, i.e. to extend the first training phase. Continuing the first training phase may take place in parallel or concurrently with the second training phase of the updated neural network, e.g. on a copy of the original neural network 102, 202 that is separate from the one used for the updated neural network. The assessment of the performance of the updated neural network(s) 100, 200 may, for example, be based on values and/or gradients of a performance metric (e.g. loss function) used during the second training phase.

After a loss in plasticity has been detected, one or more hyperparameters used in subsequent training of the original neural network 102, 202 (extending the first training phase) or the updated neural network, may be the same or different from the hyperparameters that were previously used in the first training phase. That is, the hyperparameters used in training the original neural network 102, 202 and/or the updated neural network 100, 200 may be adjusted in response to a loss of plasticity being detected in the original neural network 102.

### Agent Control

As previously mentioned, a method as described above can be implemented in a reinforcement learning system. The reinforcement learning system is an example of a system implemented as computer programs on one or more computers in one or more locations in which the systems, components, and techniques described are implemented. The reinforcement learning system selects actions to be performed by an agent interacting with an environment at each of multiple successive time steps. At each time step, the system receives data characterizing the current state of the environment, e.g., an image of the environment, and selects an action to be performed by the agent in response to the received data. Data characterizing a state of the environment is referred herein as an observation.

Once the reinforcement learning system selects an action to be performed by the agent, the reinforcement learning system can cause the agent to perform the selected action. For example, the system can instruct the agent and the agent can perform the selected action. As another example, the system can directly generate control signals for one or more controllable elements of the agent. As yet another example, the system can transmit data specifying the selected action to a control system of the agent, which controls the agent to perform the action. Generally, the agent performing the selected action results in the environment transitioning into a different state.

The techniques described herein are widely applicable and are not limited to one specific implementation. However, for illustrative purposes, a small number of example implementations are described below.

In some implementations, the environment is a real-world environment, the agent is a mechanical agent interacting with the real-world environment, e.g., a robot or an autonomous or semi-autonomous land, air, or sea vehicle operating in or navigating through the environment, and the actions are actions taken by the mechanical agent in the real-world environment to perform the task. For example, the agent may be a robot interacting with the environment to accomplish a specific task, e.g., to locate or manipulate an object of interest in the environment or to move an object of interest to a specified location in the environment or to navigate to a specified destination in the environment.

In these implementations, the observations may include, e.g., one or more of: images, object position data, and sensor data to capture observations as the agent interacts with the environment, for example sensor data from an image, distance, or position sensor or from an actuator. For example in the case of a robot, the observations may include data characterizing the current state of the robot, e.g., one or more of: joint position, joint velocity, joint force, torque or acceleration, e.g., gravity-compensated torque feedback, and global or relative pose of an item held by the robot. In the case of a robot or other mechanical agent or vehicle the observations may similarly include one or more of the position, linear or angular velocity, force, torque or acceleration, and global or relative pose of one or more parts of the agent. The observations may be defined in 1, 2 or 3 dimensions, and may be absolute and/or relative observations. The observations may also include, for example, sensed electronic signals such as motor current or a temperature signal; and/or image or video data for example from a camera or a LIDAR sensor, e.g., data from sensors of the agent or data from sensors that are located separately from the agent in the environment.

In these implementations, the actions may be control signals to control the robot or other mechanical agent, e.g., torques for the joints of the robot or higher-level control commands, or the autonomous or semi-autonomous land, air, sea vehicle, e.g., torques to the control surface or other control elements e.g. steering control elements of the vehicle, or higher-level control commands. The control signals can include for example, position, velocity, or force/torque/acceleration data for one or more joints of a robot or parts of another mechanical agent. The control signals may also or instead include electronic control data such as motor control data, or more generally data for controlling one or more electronic devices within the environment the control of which has an effect on the observed state of the environment. For example in the case of an autonomous or semi-autonomous land or air or sea vehicle the control signals may define actions to control navigation e.g. steering, and movement e.g., braking and/or acceleration of the vehicle.

In some implementations the environment is a simulation of the above-described real-world environment, and the agent is implemented as one or more computers interacting with the simulated environment. For example the simulated environment may be a simulation of a robot or vehicle and the reinforcement learning system may be trained on the simulation and then, once trained, used in the real-world.

In some implementations the environment is a real-world manufacturing environment for manufacturing a product, such as a chemical, biological, or mechanical product, or a food product. As used herein a “manufacturing” a product also includes refining a starting material to create a product, or treating a starting material e.g. to remove pollutants, to generate a cleaned or recycled product. The manufacturing plant may comprise a plurality of manufacturing units such as vessels for chemical or biological substances, or machines, e.g. robots, for processing solid or other materials. The manufacturing units are configured such that an intermediate version or component of the product is moveable between the manufacturing units during manufacture of the product, e.g. via pipes or mechanical conveyance. As used herein manufacture of a product also includes manufacture of a food product by a kitchen robot.

The agent may comprise an electronic agent configured to control a manufacturing unit, or a machine such as a robot, that operates to manufacture the product. That is, the agent may comprise a control system configured to control the manufacture of the chemical, biological, or mechanical product. For example the control system may be configured to control one or more of the manufacturing units or machines or to control movement of an intermediate version or component of the product between the manufacturing units or machines.

As one example, a task performed by the agent may comprise a task to manufacture the product or an intermediate version or component thereof. As another example, a task performed by the agent may comprise a task to control, e.g. minimize, use of a resource such as a task to control electrical power consumption, or water consumption, or the consumption of any material or consumable used in the manufacturing process.

The actions may comprise control actions to control the use of a machine or a manufacturing unit for processing a solid or liquid material to manufacture the product, or an intermediate or component thereof, or to control movement of an intermediate version or component of the product within the manufacturing environment e.g. between the manufacturing units or machines. In general the actions may be any actions that have an effect on the observed state of the environment, e.g. actions configured to adjust any of the sensed parameters described below. These may include actions to adjust the physical or chemical conditions of a manufacturing unit, or actions to control the movement of mechanical parts of a machine or joints of a robot. The actions may include actions imposing operating conditions on a manufacturing unit or machine, or actions that result in changes to settings to adjust, control, or switch on or off the operation of a manufacturing unit or machine.

The rewards or return may relate to a metric of performance of the task. For example in the case of a task that is to manufacture a product the metric may comprise a metric of a quantity of the product that is manufactured, a quality of the product, a speed of production of the product, or to a physical cost of performing the manufacturing task, e.g. a metric of a quantity of energy, materials, or other resources, used to perform the task. In the case of a task that is to control use of a resource the metric may comprise any metric of usage of the resource.

In general observations of a state of the environment may comprise any electronic signals representing the functioning of electronic and/or mechanical items of equipment. For example a representation of the state of the environment may be derived from observations made by sensors sensing a state of the manufacturing environment, e.g. sensors sensing a state or configuration of the manufacturing units or machines, or sensors sensing movement of material between the manufacturing units or machines. As some examples such sensors may be configured to sense mechanical movement or force, pressure, temperature; electrical conditions such as current, voltage, frequency, impedance; quantity, level, flow/movement rate or flow/movement path of one or more materials; physical or chemical conditions e.g. a physical state, shape or configuration or a chemical state such as pH; configurations of the units or machines such as the mechanical configuration of a unit or machine, or valve configurations; image or video sensors to capture image or video observations of the manufacturing units or of the machines or movement; or any other appropriate type of sensor. In the case of a machine such as a robot the observations from the sensors may include observations of position, linear or angular velocity, force, torque or acceleration, or pose of one or more parts of the machine, e.g. data characterizing the current state of the machine or robot or of an item held or processed by the machine or robot. The observations may also include, for example, sensed electronic signals such as motor current or a temperature signal, or image or video data for example from a camera or a LIDAR sensor. Sensors such as these may be part of or located separately from the agent in the environment.

In some implementations the environment is the real-world environment of a service facility comprising a plurality of items of electronic equipment, such as a server farm or data center, for example a telecommunications data center, or a computer data center for storing or processing data, or any service facility. The service facility may also include ancillary control equipment that controls an operating environment of the items of equipment, for example environmental control equipment such as temperature control e.g. cooling equipment, or air flow control or air conditioning equipment such as a heater, a cooler, a humidifier, or other hardware that modifies a property of air in the real-world environment. The task may comprise a task to control, e.g. minimize, use of a resource, such as a task to control electrical power consumption, or water consumption. The agent may comprise an electronic agent configured to control operation of the items of equipment, or to control operation of the ancillary, e.g. environmental, control equipment.

In general the actions may be any actions that have an effect on the observed state of the environment, e.g. actions configured to adjust any of the sensed parameters described below. These may include actions to control, or to impose operating conditions on, the items of equipment or the ancillary control equipment, e.g. actions that result in changes to settings to adjust, control, or switch on or off the operation of an item of equipment or an item of ancillary control equipment.

In general observations of a state of the environment may comprise any electronic signals representing the functioning of the facility or of equipment in the facility. For example a representation of the state of the environment may be derived from observations made by any sensors sensing a state of a physical environment of the facility or observations made by any sensors sensing a state of one or more of items of equipment or one or more items of ancillary control equipment. These include sensors configured to sense electrical conditions such as current, voltage, power or energy; a temperature of the facility; fluid flow, temperature or pressure within the facility or within a cooling system of the facility; or a physical facility configuration such as whether or not a vent is open.

The rewards or return may relate to a metric of performance of the task. For example in the case of a task to control, e.g. minimize, use of a resource, such as a task to control use of electrical power or water, the metric may comprise any metric of use of the resource.

In some implementations the environment is the real-world environment of a power generation facility e.g. a renewable power generation facility such as a solar farm or wind farm. The task may comprise a control task to control power generated by the facility, e.g. to control the delivery of electrical power to a power distribution grid, e.g. to meet demand or to reduce the risk of a mismatch between elements of the grid, or to maximize power generated by the facility. The agent may comprise an electronic agent configured to control the generation of electrical power by the facility or the coupling of generated electrical power into the grid. The actions may comprise actions to control an electrical or mechanical configuration of an electrical power generator such as the electrical or mechanical configuration of one or more renewable power generating elements e.g. to control a configuration of a wind turbine or of a solar panel or panels or mirror, or the electrical or mechanical configuration of a rotating electrical power generation machine. Mechanical control actions may, for example, comprise actions that control the conversion of an energy input to an electrical energy output, e.g. an efficiency of the conversion or a degree of coupling of the energy input to the electrical energy output. Electrical control actions may, for example, comprise actions that control one or more of a voltage, current, frequency or phase of electrical power generated.

The rewards or return may relate to a metric of performance of the task. For example in the case of a task to control the delivery of electrical power to the power distribution grid the metric may relate to a measure of power transferred, or to a measure of an electrical mismatch between the power generation facility and the grid such as a voltage, current, frequency or phase mismatch, or to a measure of electrical power or energy loss in the power generation facility. In the case of a task to maximize the delivery of electrical power to the power distribution grid the metric may relate to a measure of electrical power or energy transferred to the grid, or to a measure of electrical power or energy loss in the power generation facility.

In general observations of a state of the environment may comprise any electronic signals representing the electrical or mechanical functioning of power generation equipment in the power generation facility. For example a representation of the state of the environment may be derived from observations made by any sensors sensing a physical or electrical state of equipment in the power generation facility that is generating electrical power, or the physical environment of such equipment, or a condition of ancillary equipment supporting power generation equipment. Such observations may thus include observations of wind levels or solar irradiance, or of local time, date, or season. Such sensors may include sensors configured to sense electrical conditions of the equipment such as current, voltage, power or energy; temperature or cooling of the physical environment; fluid flow; or a physical configuration of the equipment; and observations of an electrical condition of the grid e.g. from local or remote sensors. Observations of a state of the environment may also comprise one or more predictions regarding future conditions of operation of the power generation equipment such as predictions of future wind levels or solar irradiance or predictions of a future electrical condition of the grid.

As another example, the environment may be a chemical synthesis or protein folding environment such that each state is a respective state of a protein chain or of one or more intermediates or precursor chemicals and the agent is a computer system for determining how to fold the protein chain or synthesize the chemical. In this example, the actions are possible folding actions for folding the protein chain or actions for assembling precursor chemicals/intermediates and the result to be achieved may include, e.g., folding the protein so that the protein is stable and so that it achieves a particular biological function or providing a valid synthetic route for the chemical. As another example, the agent may be a mechanical agent that performs or controls the protein folding actions or chemical synthesis steps selected by the system automatically without human interaction. The observations may comprise direct or indirect observations of a state of the protein or chemical/intermediates/precursors and/or may be derived from simulation.

In a similar way the environment may be a drug design environment such that each state is a respective state of a potential pharmaceutically active compound pharmaceutically active compound and the agent is a computer system for determining elements of the pharmaceutically active compound and/or a synthetic pathway for the pharmaceutically active compound. The drug/synthesis may be designed based on a reward derived from a target for the pharmaceutically active compound, for example in simulation. As another example, the agent may be a mechanical agent that performs or controls synthesis of the pharmaceutically active compound.

In some applications the agent may be a software agent i.e. a computer program, configured to perform a task. For example the environment may be a circuit or an integrated circuit design or routing environment and the agent may be configured to perform a design or routing task for routing interconnection lines of a circuit or of an integrated circuit e.g. an ASIC. The reward(s) may then be dependent on one or more routing metrics such as interconnect length, resistance, capacitance, impedance, loss, speed or propagation delay; and/or physical line parameters such as width, thickness or geometry, and design rules. The reward(s) may also or instead include one or more reward(s) relating to a global property of the routed circuitry e.g. component density, operating speed, power consumption, material usage, a cooling requirement, level of electromagnetic emissions, and so forth. The observations may be e.g. observations of component positions and interconnections; the actions may comprise component placing actions e.g. to define a component position or orientation and/or interconnect routing actions e.g. interconnect selection and/or placement actions. The task may be, e.g., to optimize circuit operation to reduce electrical losses, local or external interference, or heat generation, or to increase operating speed, or to minimize or optimize usage of available circuit area. The method may include making the circuit or integrated circuit to the design, or with interconnection lines routed as determined by the method.

In some applications the agent is a software agent and the environment is a real-world computing environment. In one example the agent manages distribution of tasks across computing resources e.g. on a mobile device and/or in a data center. In these applications, the observations may include observations of computing resources such as compute and/or memory capacity, or Internet-accessible resources; and the actions may include assigning tasks to particular computing resources. The reward(s) may be configured to maximize or minimize one or more of: utilization of computing resources, electrical power, bandwidth, and computation speed.

In another example the software agent manages the processing, e.g. by one or more real-world servers, of a queue of continuously arriving jobs. The observations may comprise observations of the times of departures of successive jobs, or the time intervals between the departures of successive jobs, or the time a server takes to process each job, e.g. the start and end of a range of times, or the arrival times, or time intervals between the arrivals, of successive jobs, or data characterizing the type of job(s). The actions may comprise actions that allocate particular jobs to particular computing resources; the reward(s) may be configured to minimize an overall queueing or processing time or the queueing or processing time for one or more individual jobs, or in general to optimize any metric based on the observations.

As another example the environment may comprise a real-world computer system or network, the observations may comprise any observations characterizing operation of the computer system or network, the actions performed by the software agent may comprise actions to control the operation e.g. to limit or correct abnormal or undesired operation e.g. because of the presence of a virus or other security breach, and the reward(s) may comprise any metric(s) that characterizing desired operation of the computer system or network.

In some applications, the environment is a real-world computing environment and the software agent manages distribution of tasks/jobs across computing resources e.g. on a mobile device and/or in a data center. In these implementations, the observations may comprise observations that relate to the operation of the computing resources in processing the tasks/jobs, the actions may include assigning tasks/jobs to particular computing resources, and the reward(s) may relate to one or more metrics of processing the tasks/jobs using the computing resources, e.g. metrics of usage of computational resources, bandwidth, or electrical power, or metrics of processing time, or numerical accuracy, or one or more metrics that relate to a desired load balancing between the computing resources.

In some applications the environment is a data packet communications network environment, and the agent is part of a router to route packets of data over the communications network. The actions may comprise data packet routing actions and the observations may comprise e.g. observations of a routing table which includes routing metrics such as a metric of routing path length, bandwidth, load, hop count, path cost, delay, maximum transmission unit (MTU), and reliability. The reward(s) may be defined in relation to one or more of the routing metrics i.e. configured to maximize one or more of the routing metrics.

In some other applications the environment is an Internet or mobile communications environment and the agent is a software agent which manages a personalized recommendation for a user. The observations may comprise previous actions taken by the user, e.g. features characterizing these; the actions may include actions recommending items such as content items to a user. The reward(s) may be configured to maximize one or more of: an estimated likelihood that the user will respond favorably to being recommended the (content) item, a suitability unsuitability of one or more recommended items, a cost of the recommended item(s), and a number of recommendations received by the user, optionally within a time span.

As a further example, the actions may include presenting advertisements, the observations may include advertisement impressions or a click-through count or rate, and the reward may characterize previous selections of items or content taken by one or more users.

In some cases, the observations may include textual or spoken instructions provided to the agent by a third-party (e.g., an operator of the agent). For example, the agent may be an autonomous vehicle, and a user of the autonomous vehicle may provide textual or spoken instructions to the agent (e.g., to navigate to a particular location).

As another example the environment may be an electrical, mechanical or electro-mechanical design environment, e.g. an environment in which the design of an electrical, mechanical or electro-mechanical entity is simulated. The simulated environment may be a simulation of a real-world environment in which the entity is intended to work. The task may be to design the entity. The observations may comprise observations that characterize the entity, i.e. observations of a mechanical shape or of an electrical, mechanical, or electro-mechanical configuration of the entity, or observations of parameters or properties of the entity. The actions may comprise actions that modify the entity e.g. that modify one or more of the observations. The rewards or return may comprise one or more metric of performance of the design of the entity. For example rewards or return may relate to one or more physical characteristics of the entity such as weight or strength or to one or more electrical characteristics of the entity such as a measure of efficiency at performing a particular function for which the entity is designed. The design process may include outputting the design for manufacture, e.g. in the form of computer executable instructions for manufacturing the entity. The process may include making the entity according to the design. Thus the design of an entity may be optimized, e.g. by reinforcement learning, and then the optimized design output for manufacturing the entity, e.g. as computer executable instructions; an entity with the optimized design may then be manufactured.

As previously described the environment may be a simulated environment. Generally in the case of a simulated environment the observations may include simulated versions of one or more of the previously described observations or types of observations and the actions may include simulated versions of one or more of the previously described actions or types of actions. For example the simulated environment may be a motion simulation environment, e.g., a driving simulation or a flight simulation, and the agent may be a simulated vehicle navigating through the motion simulation. In these implementations, the actions may be control inputs to control the simulated user or simulated vehicle. Generally the agent may be implemented as one or more computers interacting with the simulated environment.

The simulated environment may be a simulation of a particular real-world environment and agent. For example, the system may be used to select actions in the simulated environment during training or evaluation of the system and, after training, or evaluation, or both, are complete, may be deployed for controlling a real-world agent in the particular real-world environment that was the subject of the simulation. This can avoid unnecessary wear and tear on and damage to the real-world environment or real-world agent and can allow the control neural network to be trained and evaluated on situations that occur rarely or are difficult or unsafe to re-create in the real-world environment. For example the system may be partly trained using a simulation of a mechanical agent in a simulation of a particular real-world environment, and afterwards deployed to control the real mechanical agent in the particular real-world environment. Thus in such cases the observations of the simulated environment relate to the real-world environment, and the selected actions in the simulated environment relate to actions to be performed by the mechanical agent in the real-world environment.

In some implementations the agent may not include a human being (e.g. it is a robot). Conversely, in some implementations the agent comprises a human user of a digital assistant such as a smart speaker, smart display, or other device. Then the information defining the task can be obtained from the digital assistant, and the digital assistant can be used to instruct the user based on the task.

For example, the reinforcement learning system may output to the human user, via the digital assistant, instructions for actions for the user to perform at each of a plurality of time steps. The instructions may for example be generated in the form of natural language (transmitted as sound and/or text on a screen) based on actions chosen by the reinforcement learning system. The reinforcement learning system chooses the actions such that they contribute to performing a task. A monitoring system (e.g. a video camera system) may be provided for monitoring the action (if any) which the user actually performs at each time step, in case (e.g. due to human error) it is different from the action which the reinforcement learning system instructed the user to perform. Using the monitoring system the reinforcement learning system can determine whether the task has been completed. During an on-policy training phase and/or another phase in which the history database is being generated, the experience tuples may record the action which the user actually performed based on the instruction, rather than the one which the reinforcement learning system instructed the user to perform. The reward value of each experience tuple may be generated, for example, by comparing the action the user took with a corpus of data showing a human expert performing the task, e.g. using techniques known from imitation learning. Note that if the user performs actions incorrectly (i.e. performs a different action from the one the reinforcement learning system instructs the user to perform) this adds one more source of noise to sources of noise which may already exist in the environment. During the training process the reinforcement learning system may identify actions which the user performs incorrectly with more than a certain probability. If so, when the reinforcement learning system instructs the user to perform such an identified action, the reinforcement learning system may warn the user to be careful. Alternatively or additionally, the reinforcement learning system may learn not to instruct the user to perform the identified actions, i.e. ones which the user is likely to perform incorrectly.

More generally, the digital assistant instructing the user may comprise receiving, at the digital assistant, a request from the user for assistance and determining, in response to the request, a series of tasks for the user to perform, e.g. steps or sub-tasks of an overall task. Then for one or more tasks of the series of tasks, e.g. for each task, e.g. until a final task of the series the digital assistant can be used to output to the user an indication of the task, e.g. step or sub-task, to be performed. This may be done using natural language, e.g. on a display and/or using a speech synthesis subsystem of the digital assistant. Visual, e.g. video, and/or audio observations of the user performing the task may be captured, e.g. using the digital assistant. A system as described above may then be used to determine whether the user has successfully achieved the task e.g. step or sub-task, i.e. from the answer as previously described. If there are further tasks to be completed the digital assistant may then, in response, progress to the next task (if any) of the series of tasks, e.g. by outputting an indication of the next task to be performed. In this way the user may be led step-by-step through a series of tasks to perform an overall task. During the training of the neural network, training rewards may be generated e.g. from video data representing examples of the overall task (if corpuses of such data are available) or from a simulation of the overall task.

As an illustrative example a user may be interacting with a digital assistant and ask for help performing an overall task consisting of multiple steps, e.g. cooking a pasta dish. While the user performs the task, the digital assistant receives audio and/or video inputs representative of the user's progress on the task, e.g. images or video or sound clips of the user cooking. The digital assistant uses a system as described above, in particular by providing it with the captured audio and/or video and a question that asks whether the user has completed a particular step, e.g. ‘Has the user finished chopping the peppers?’, to determine whether the user has successfully completed the step. If the answer confirms that the use has successfully completed the step then the digital assistant progresses to telling the user to perform the next step or, if at the end of the task, or if the overall task is a single-step task, then the digital assistant may indicate this to the user. The digital assistant may then stop receiving or processing audio and/or video inputs to ensure privacy and/or reduce power use.

In a further aspect there is provided a digital assistant device including a system as described above. The digital assistant can also include a user interface to enable a user to request assistance and to output information. In implementations this is a natural language user interface and may comprise a keyboard, voice input-output subsystem, and/or a display. The digital assistant can further include an assistance subsystem configured to determine, in response to the request, a series of tasks for the user to perform. In implementations this may comprise a generative (large) language model, in particular for dialog, e.g. a conversation agent such as LaMDA, Sparrow, or Chinchilla. The digital assistant can have an observation capture subsystem to capture visual and/or audio observations of the user performing a task; and an interface for the above-described language model neural network (which may be implemented locally or remotely). The digital assistant can also have an assistance control subsystem configured to assist the user. The assistance control subsystem can be configured to perform the steps described above, for one or more tasks e.g. of a series of tasks, e.g. until a final task of the series. More particularly the assistance control subsystem and output to the user an indication of the task to be performed, capture, using the observation capture subsystem, visual or audio observations of the user performing the task, determine from the above-described answer whether the user has successfully achieved the task. In response the digital assistant can progress to a next task of the series of tasks and/or control the digital assistant, e.g. to stop capturing observations.

In the implementations above, the environment may not include a human being or animal. In other implementations, however, it may comprise a human being or animal. For example, the agent may be an autonomous vehicle in an environment which is a location (e.g. a geographical location) where there are human beings (e.g. pedestrians or drivers/passengers of other vehicles) and/or animals, and the autonomous vehicle itself may optionally contain human beings. The environment may also be at least one room (e.g. in a habitation) containing one or more people. The human being or animal may be an element of the environment which is involved in the task, e.g. modified by the task (indeed, the environment may substantially consist of the human being or animal). For example the environment may be a medical or veterinary environment containing at least one human or animal subject, and the task may relate to performing a medical (e.g. surgical) procedure on the subject. In a further implementation, the environment may comprise a human user who interacts with an agent which is in the form of an item of user equipment, e.g. a digital assistant. The item of user equipment provides a user interface between the user and a computer system (the same computer system(s) which implement the reinforcement learning system, or a different computer system). The user interface may allow the user to enter data into and/or receive data from the computer system, and the agent is controlled by the action selection policy to perform an information transfer task in relation to the user, such as providing information about a topic to the user and/or allowing the user to specify a component of a task which the computer system is to perform. For example, the information transfer task may be to teach the user a skill, such as how to speak a language or how to navigate around a geographical location; or the task may be to allow the user to define a three-dimensional shape to the computer system, e.g. so that the computer system can control an additive manufacturing (3D printing) system to produce an object having the shape. Actions may comprise outputting information to the user (e.g. in a certain format, at a certain rate, etc.) and/or configuring the interface to receive input from the user. For example, an action may comprise setting a problem for a user to perform relating to the skill (e.g. asking the user to choose between multiple options for correct usage of the language, or asking the user to speak a passage of the language out loud), and/or receiving input from the user (e.g. registering selection of one of the options, or using a microphone to record the spoken passage of the language). Rewards may be generated based upon a measure of how well the task is performed. For example, this may be done by measuring how well the user learns the topic, e.g. performs instances of the skill (e.g. as measured by an automatic skill evaluation unit of the computer system). In this way, a personalized teaching system may be provided, tailored to the aptitudes and current knowledge of the user. In another example, when the information transfer task is to specify a component of a task which the computer system is to perform, the action may comprise presenting a (visual, haptic or audio) user interface to the user which permits the user to specify an element of the component of the task, and receiving user input using the user interface. The rewards may be generated based on a measure of how well and/or easily the user can specify the component of the task for the computer system to perform, e.g. how fully or well the three-dimensional object is specified. This may be determined automatically, or a reward may be specified by the user, e.g. a subjective measure of the user experience. In this way, a personalized system may be provided for the user to control the computer system, again tailored to the aptitudes and current knowledge of the user.

Optionally, in any of the above implementations, the observation at any given time step may include data from a previous time step that may be beneficial in characterizing the environment, e.g., the action performed at the previous time step, the reward received at the previous time step, or both.

### Sequence-to-Sequence

In some implementations, the network input may comprise an input sequence (of data elements) and/or the network output may comprise an output sequence (of data elements). For example network input and the network output may each comprise a sequence of tokens.

For example in some implementations the input tokens and the output tokens each represent words, wordpieces or characters in a natural language. A wordpiece may be a sub-word (part of a word), and may be an individual letter or character. As used here, “characters” includes Chinese and other similar characters, as well as logograms, syllabograms and the like.

Some of these implementations may be used for natural language tasks such as providing a natural language response to a natural language input, e.g. for question answering, or for text completion. In some implementations the input sequence may represent text in a natural language and the output sequence may represent text in the same natural language, e.g. a longer item of text. For example in some implementations the input sequence may represent text in a natural language and the output sequence may represent the same text with a missing portion of the text added or filled in. For example the output sequence may represent a predicted completion of text represented by the input sequence. Such an application may be used, e.g. to provide an auto-completion function e.g. for natural language-based search. In some implementations the input sequence may represent a text in a natural language e.g. posing a question or defining a topic, and the output sequence may represent a text in a natural language which is a response to the question or about the specified topic.

As another example the input sequence may represent a first item of text and the output sequence may represent a second, shorter item of text e.g. the second item of text may be a summary of a passage that is the first item of text. As another example the input sequence may represent a first item of text and the output sequence may represent a simplification of the first item of text. As another example the input sequence may represent a first item of text and the output sequence may represent an aspect of the first item of text e.g. it may represent an entailment task, a paraphrase task, a textual similarity task, a sentiment analysis task, a sentence completion task, a grammaticality task, a parsing task, e.g., constituency parsing, and in general any natural language understanding task that operates on a sequence of text in some natural language e.g. to generate an output that classifies or predicts some property of the text. For example some implementations may be used to identify a natural language of the first item of text, or of spoken words where the input is audio (as described below).

Some implementations may be used to perform neural machine translation. Thus in some implementations the input tokens represent words, wordpieces, or characters in a first natural language and the output tokens represent words, wordpieces or characters in a second, different natural language. That is, the input sequence may represent input text in the first language and the output sequence may represent a translation of the input text into the second language.

Some implementations may be used for automatic code generation. For example the input tokens may represent words, wordpieces or characters in a first natural language and the output tokens may represent instructions in a computer programming or markup language, or instructions for controlling an application program to perform a task e.g. build a data item such as an image or web page.

Some implementations may be used for speech recognition. In such applications the input sequence may represent spoken words and the output sequence may represent a conversion of the spoken words to a machine-written representation e.g. text. Then the input tokens may comprise tokens representing an audio data input including the spoken words e.g. characterizing a waveform of the audio in the time domain or in the time-frequency domain. The output tokens may represent words, wordpieces, characters, or graphemes of a machine-written, e.g. text, representation of the spoken input, that is representing a transcription of the spoken input.

Some implementations may be used for handwriting recognition. In such applications the input sequence may represent handwritten words, syllabograms or characters and the output sequence may represent a conversion of the input sequence to a machine-written representation e.g. text. Then the input tokens may comprise tokens representing portions of the handwriting and the output tokens may represent words, wordpieces, characters or graphemes of a machine-written, e.g. text, representation of the spoken input.

Some implementations may be used for text-to-speech conversion. In such applications the input sequence may represent text and the output sequence may represent a conversion of the text to spoken words. Then the input tokens may comprise tokens representing words or wordpieces or graphemes of the text and the output tokens may represent portions of audio data for generating speech corresponding to the text, e.g. tokens characterizing a portion of a waveform of the speech in the time domain or in the time-frequency domain, or phonemes.

In some implementations, the input sequence and the output sequence represent different modalities of input. For example the input sequence may represent text in a natural language and the output sequence may represent an image or video corresponding to the text; or vice-versa. In general the tokens may represent image or video features and a sequence of such tokens may represent an image or video. There are many ways to represent an image (or video) using tokens. As one example an image (or video) may be represented as a sequence of regions of interest (RoIs) in the image, optionally including one or more tokens for global image features. For example an image may be encoded using a neural network to extract Rol features; optionally (but not essentially) a token may also include data, e.g. a position encoding, representing a position of the Rol in the image. As another example, the tokens may encode color or intensity values for pixels of an image. As another example, some image processing neural network systems e.g. autoregressive systems, naturally represent images as sequences of image features.

As another example, a transformer-based sequence-to-sequence neural network may be used to process images instead of or as well as text (e.g. if trained on images instead of or as well as text).

Thus in some implementations at least one of the input sequence and the output sequence is a sequence representing an image or video, and the tokens represent the image or video. For example the input sequence may be a sequence of text, the input tokens may represent words, wordpieces, or characters and the output sequence may comprise output tokens representing an image or video e.g. described by the text, or providing a visual answer to a question posed by the text, or providing a visualization of a topic of the text. In another example the input sequence may comprise a sequence of input tokens representing an image or video, and the output tokens may represent words or wordpieces, or characters representing text e.g. for a description or characterization of the image or video, or providing an answer to a question posed visually by the image or video, or providing information on a topic of a topic of the image or video.

In some other implementations, both the input sequence and the output sequence may represent an image or video, and both the input tokens and the output tokens may represent a respective image or video. In such implementations the method/system may be configured to perform an image or video transformation. For example the input sequence and the output sequence may represent the same image or video in different styles e.g. one as an image the other as a sketch of the image; or different styles for the same item of clothing.

In some implementations the input sequence represents data to be compressed, e.g. image data, text data, audio data, or any other type of data; and the output sequence a compressed version of the data. The input and output tokens may each comprise any representation of the data to be compressed/compressed data e.g. symbols or embeddings generated/decoded by a respective neural network.

In some implementations, the input sequence represents a time series and the output sequence may comprise a continuation of the time series. For example the input sequence may be a sequence representing the output of an electricity generating plant, e.g. a solar or wind electricity generating plant, or a sequence representing electricity consumption, and the output sequence may provide a forecast of the electricity generated or consumed. As another example the input sequence may be a sequence representing a level of traffic on one or more roads and the output sequence may provide a forecast of the future traffic.

### Other Data Processing

The original/updated neural network can be configured to generate any appropriate network output that characterizes one or more entities represented by the network input, e.g. the values of pixels of a still or moving image or a time series of samples of an audio waveform. For example, the network output can be a classification output (to classify the entity), a regression output, a sequence output (i.e., that includes a sequence of output elements), a segmentation output, or a combination thereof. As some further examples the network output can provide semantic or instance segmentation of or can define one or more bounding boxes around the one or more entities in the network input.

In some implementations, the network input may represent the values of pixels of a still or moving image and original/updated neural network is configured to perform an image processing task, e.g. image classification, image recognition, or semantic or instance segmentation. For example the network output may comprise a classification output, e.g. that includes a respective score for each object category in a set of possible object categories, defining a likelihood that the image depicts an object that belongs to the object category, or (for segmentation) may provide a classification output for each pixel.

In some implementations the network input may represent audio samples of an audio waveform and the original/updated neural network is configured to perform an audio processing task e.g. a speech or other audio recognition task. Such a task may be to generate a network output that defines a sequence of phonemes, graphemes, characters, or words corresponding to the audio waveform, or to recognize a word such as a “hotword” or to recognize another audio sound.

In some implementations, the original/updated neural network can perform a conditional image generation task, where the network input represents a conditioning input, e.g. text, and the network output defines a sequence of intensity value inputs for the pixels of an image.

In some implementations, the original/updated neural network can perform a point cloud processing task, e.g., where the network input represents a point cloud (e.g., generated by a lidar or radar sensor) and the network output characterizes, e.g., a type of object represented by the point cloud.

In some implementations, the original/updated neural network is configured to perform a combination of multiple individual machine learning tasks, e.g., two or more of the machine learning tasks mentioned above.

In some implementations the network input comprises data element embeddings that represent an entity such as an image (which here includes video represented a sequence of video frames), an audio waveform, a point cloud, a protein, a sequence of words, or any combination thereof, e.g. multimodal data. The network output can characterize the entity or a result of performing a processing task on the entity, e.g. a task of recognizing the entity or of generating a caption (text) that describes the entity.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method, performed by one or more computers, of reducing plasticity loss when training a neural network, the method comprising:
obtaining an original neural network including an output subnetwork, wherein the original neural network is configured to process a network input in accordance with trainable parameters of the original neural network to generate, from the output subnetwork, an original network output;
training the original neural network during a first training phase, wherein the training comprises processing first training data items using the original neural network to generate original network outputs for the first training data items, and updating the trainable parameters of the original neural network using the original network outputs;
creating first and second versions of the output subnetwork;
forming an updated neural network comprising the original neural network and the first and second versions of the output subnetwork and configuring the updated neural network to process the network input to generate an updated network output from a combination of the original network output, a first network output from the first version of the output subnetwork, and a second network output from the second version of the output subnetwork;
initializing trainable parameters of the first and second versions of the output subnetwork;
freezing the trainable parameters of the second version of the output subnetwork after the initializing; and
training the updated neural network during a second training phase, wherein the training comprises processing second training data items using the updated neural network to generate updated network outputs for the second training data items, and updating the trainable parameters of the updated neural network that are not frozen, using the updated network outputs.

2. The method of claim 1, wherein initializing trainable parameters of the first and second versions of the output subnetwork comprises:
initializing the trainable parameters of the first version of the output subnetwork, and then
initializing the trainable parameters of the second version of the output subnetwork to the values of the corresponding trainable parameters of the first version of the output subnetwork, the method further comprising:
generating the updated network output by summing the original network output and the first network output and subtracting the second network output.

3. The method of claim 1, further comprising freezing the trainable parameters of the output subnetwork before the second training phase.

4. The method of claim 1, comprising generating the updated network output by determining
$$h ( x ) + {h}_{1}^{′} ( x ) - {h}_{2}^{′} ( x )$$
where h(x) is the original network output,
$${h}_{1}^{′} ( x )$$
is the first network output, and
$${h}_{2}^{′} ( x )$$
is the second network output.

5. The method of claim 1, wherein the first and second versions of the output subnetwork have the same neural network architecture as one another.

6. The method of claim 1, wherein the first and second versions of the output subnetwork are first and second copies of the output subnetwork.

7. The method of claim 1, wherein training the updated neural network comprises backpropagating gradients of a training objective function through each of the output subnetwork, the first version of the output subnetwork, and the second version of the output subnetwork to update the trainable parameters of the updated neural network that are not frozen.

8. The method of claim 1, wherein the original neural network further comprises a second subnetwork configured to process the network input, in accordance with trainable parameters of the second subnetwork, to generate a second subnetwork output, and wherein the output subnetwork is configured to process the second subnetwork output to generate the original network output; and
wherein forming the updated neural network comprises sharing the second subnetwork between the original neural network and the first and second versions of the output subnetworks;
the method further comprising:
processing the network input using the second subnetwork to generate the second subnetwork output, and
processing the second subnetwork output using the output subnetwork, the first version of the output subnetwork, and the second version of the output subnetwork to generate the updated network output.

9. The method of claim 8, wherein training the updated neural network includes updating the trainable parameters of the second subnetwork.

10. The method of claim 1, comprising:
creating first and second versions of the complete original neural network;
initializing trainable parameters of the first and second versions of the original neural network; and
freezing the trainable parameters of the second version of the original neural network after the initializing;
wherein the updated neural network comprises the original neural network and the first and second versions of the original neural network,
the method further comprising:
processing the network input using the original neural network, the first version of the original neural network, and the second version of the original neural network; generating the first network output from the first version of the original neural network; and generating the second network output from the second version of the original neural network.

11. The method of claim 1, wherein the original neural network further comprises a second subnetwork configured to process the network input, in accordance with trainable parameters of the second subnetwork, to generate a second subnetwork output, and wherein the output subnetwork is configured to process the second subnetwork output to generate the original network output; the method further comprising:
creating first and second versions of the second subnetwork;
initializing trainable parameters of the first and second versions of the second subnetwork to values of the trainable parameters of the second subnetwork; and
freezing the trainable parameters of the second version of the second subnetwork; and wherein
forming the updated neural network comprises configuring the updated neural network to process the network input using each of i) the second subnetwork, ii) the first version of the second subnetwork, and iii) the second version of the second subnetwork, to generate respective outputs processed by i) the output subnetwork, ii) the first version of the output subnetwork, and iii) the second version of the output subnetwork.

12. The method of claim 1, further comprising detecting loss of plasticity during the first training phase and, in response, forming and training the updated neural network.

13. The method of claim 11, wherein detecting the loss of plasticity comprises determining a norm of the trainable parameters of the original neural network, and using the norm to detect the loss of plasticity.

14. The method of claim 1, comprising:
saving a checkpoint of the original neural network during the first training phase, the checkpoint comprising a set of values for the trainable parameters of the original neural network;
detecting loss of plasticity in the original neural network by comparing a metric of performance of the original and updated neural networks;
restoring the original neural network using the saved checkpoint in response to detecting loss of plasticity; and
continuing training of the original neural network from the saved checkpoint using a modified training process.

15. The method of claim 1, wherein training the updated neural network during the second training phase comprises training the updated neural network on enhanced hardware compared with hardware used for training the original neural network during the first training phase.

16. (canceled)

17. (canceled)

18. (canceled)

19. One or more computer-readable storage media storing instructions that when executed by one or more computers cause the one or more computers to perform operations for reducing plasticity loss when training a neural network, the operations comprising:
obtaining an original neural network including an output subnetwork, wherein the original neural network is configured to process a network input in accordance with trainable parameters of the original neural network to generate, from the output subnetwork, an original network output;
training the original neural network during a first training phase, wherein the training comprises processing first training data items using the original neural network to generate original network outputs for the first training data items, and updating the trainable parameters of the original neural network using the original network outputs;
creating first and second versions of the output subnetwork;
forming an updated neural network comprising the original neural network and the first and second versions of the output subnetwork and configuring the updated neural network to process the network input to generate an updated network output from a combination of the original network output, a first network output from the first version of the output subnetwork, and a second network output from the second version of the output subnetwork;
initializing trainable parameters of the first and second versions of the output subnetwork;
freezing the trainable parameters of the second version of the output subnetwork after the initializing; and
training the updated neural network during a second training phase, wherein the training comprises processing second training data items using the updated neural network to generate updated network outputs for the second training data items, and updating the trainable parameters of the updated neural network that are not frozen, using the updated network outputs.

20. A system comprising one or more computers and one or more storage devices storing instructions that when executed by one or more computers cause the one or more computers to perform operations for reducing plasticity loss when training a neural network, the operations comprising:
obtaining an original neural network including an output subnetwork, wherein the original neural network is configured to process a network input in accordance with trainable parameters of the original neural network to generate, from the output subnetwork, an original network output;
training the original neural network during a first training phase, wherein the training comprises processing first training data items using the original neural network to generate original network outputs for the first training data items, and updating the trainable parameters of the original neural network using the original network outputs;
creating first and second versions of the output subnetwork;
forming an updated neural network comprising the original neural network and the first and second versions of the output subnetwork and configuring the updated neural network to process the network input to generate an updated network output from a combination of the original network output, a first network output from the first version of the output subnetwork, and a second network output from the second version of the output subnetwork;
initializing trainable parameters of the first and second versions of the output subnetwork;
freezing the trainable parameters of the second version of the output subnetwork after the initializing; and
training the updated neural network during a second training phase, wherein the training comprises processing second training data items using the updated neural network to generate updated network outputs for the second training data items, and updating the trainable parameters of the updated neural network that are not frozen, using the updated network outputs.
